(19) United States
(12) Patent Application Publication
(10) Pub. No.: US 2017/0008618 A1
(43) Pub. Date: Jan. 12, 2017

(54) OPTIMIZING GROUND MOVEMENT IN AIRCRAFT EQUIPPED WITH NON-ENGINE DRIVE MEANS

(71) Applicant: Borealis Technical Limited, North Plains, OR (US)

(72) Inventors: Joseph J. Cox, Portland, OR (US); Isaiah W. Cox, London (GB); Jan Vana, Prague (CZ); Rodney T. Cox, North Plains, OR (US)

(73) Assignee: Borealis Technical Limited, North Plains, OR (US)

(21) Appl. No.: 15/274,810

(22) Filed: Sep. 23, 2016

Related U.S. Application Data
(63) Continuation-in-part of application No. 14/341,765, filed on Jul. 26, 2014.

(51) Int. Cl. B64C 25/40; B64D 27/02; B64C 25/34

(52) U.S. Cl. CPC B64C 25/405; B64C 25/34; B64D 27/02

(57) ABSTRACT

A method is provided for maximizing efficiency of ground travel in aircraft equipped with landing gear wheel-mounted non-engine drive motors for autonomous ground travel. Selective operation of the non-engine drive motors and selective operation of the aircraft's engines are integrated to power aircraft movement when different ground travel speeds or airport ground travel conditions require operation of engines or non-engine drive motors for optimal efficiency of aircraft ground travel. The non-engine drive motors may be specifically designed to move aircraft at lower speeds optimal for ground maneuvers in a ramp area or elsewhere, and one or more of the aircraft's engines may be operated at a thrust level that moves the aircraft efficiently at higher taxi speeds.

### PRIORITY CLAIM

This application is a continuation-in-part of U.S. patent application Ser. No. 14/341,765, filed 26 Jul. 2014, which claims priority from International Patent Application No. PCT/US2014/031111, filed 18 Mar. 2014, the disclosure of which is fully incorporated herein by reference.

### TECHNICAL FIELD

The present invention relates generally to the movement of aircraft taxiing on the ground between landing and takeoff and at other times requiring aircraft ground travel and specifically to a ground movement system and method for maximizing the efficiency of ground movement and optimizing time and other savings possible when aircraft are equipped with onboard landing gear wheel-mounted non-engine drive motors controllable in conjunction with operation of the aircraft's engines to move the aircraft during ground travel.

### BACKGROUND OF THE INVENTION

Moving aircraft efficiently on the ground between landing and takeoff has received much attention recently. The time required to move aircraft between landing and taxi is a consideration. In addition, approximately 5% of an aircraft's total fuel usage is consumed during ground travel. Reducing the amount of fuel needed by an aircraft during ground movement is accompanied by significant benefits that include not only reduced fuel costs resulting from reduced fuel consumption, but reduced carbon emissions and noise. Currently, aircraft are moved between runways and gates or other airport parking locations by operation of one or more of an aircraft's engines and/or by attachment to external tow vehicles that does not require aircraft engine operation. These methods of ground travel may be time consuming and may not be particularly efficient, but are used by virtually all aircraft.

Alternative methods of moving aircraft on the ground without operation of aircraft engines to reduce fuel usage and increase efficiency have been proposed. These methods include, for example, automated tug vehicles that attach externally to an aircraft to guide its travel and onboard drive means that power one or more landing gear wheels to move an aircraft during ground travel. Unmanned aircraft transfer systems and automated towing vehicles capable of moving aircraft on the ground are described, respectively, in U.S. Pat. No. 7,975,959 by Perry et al and U.S. Pat. No. 6,305,484 by LeBlanc. Using a self-propelled undercarriage wheel to move an aircraft autonomously along taxiways is proposed by Cox et al in U.S. Pat. No. 7,891,609, owned in common with the present application.

While the foregoing systems and methods for moving aircraft during ground travel represent ways in which operating efficiency and fuel reduction may be achieved, the operation of such systems and methods during all ground travel may not be optimally efficient for all aircraft. Wide-body aircraft, for example, which often must be maneuvered into and out of ramp areas somewhat differently than narrow body or smaller aircraft may require a different approach to the control of ground travel. In addition, airport conditions may require a different approach to controlling aircraft ground movement than has been proposed. Not all airport ground surfaces are flat and level, for example.

Aircraft are currently parked at airport terminals and gates with the nose end of the aircraft pointed toward the terminal or gate. This parking orientation is used because aircraft presently use engines to power travel from a landing location on a runway to a parking location within an airport ramp area. When an aircraft's engines are operating, jet blast and engine ingestion can compromise the safety of persons and ground equipment within the engine hazard area, especially near a gate or terminal where there are likely to be more persons, ground equipment, and other aircraft. When all aircraft are parked in the same nose-in orientation, the danger areas where engine ingestion or jet blast could occur when aircraft engines are operating are at least somewhat predictable. Other aircraft parking orientations besides the currently used nose-in orientation, however, could allow more aircraft to park at gates, stands, or other parking areas near an airport terminal. For example, parking an aircraft with the longest axis of the aircraft body parallel to the terminal or at an angle relative to the terminal other than the perpendicular orientation currently used may actually allow more efficient use of terminal parking space resources, for narrow body, wide-body, and other aircraft. The present need to use aircraft engines to drive aircraft within aprons and ramp areas to terminal gates and other parking areas, however, prohibits the use of these and potentially other aircraft parking orientations because of the risks of jet blast and engine ingestion dangers associated with aircraft engine operation.

A need exists for a method for improving and optimizing the efficiency of aircraft ground travel that enables aircraft equipped with onboard non-engine drive motors for autonomous ground movement to travel on the ground between landing and takeoff and park at or near a terminal with greater safety and efficiency than is now possible. A method is needed that integrates operation of both aircraft engines and non-engine drive motors to power ground travel as appropriate between landing and takeoff.

### SUMMARY OF THE INVENTION

It is a primary object of the present invention to provide a method for optimizing efficiency of ground travel of aircraft equipped with onboard non-engine drive motors for autonomous ground movement that enables maximally efficient low speed ground movement of aircraft into and out of airport ramp areas and parking locations, as well as maximally efficient higher speed ground travel during taxi on taxiways and runways.

It is another object of the present invention to provide a method that integrates operation of aircraft engines and non-engine drive motors to enable aircraft equipped with non-engine drive motors for autonomous ground movement to travel on the ground between landing and takeoff and at other times and to park at or near a terminal with significantly greater efficiency and safety than is now possible.

It is another object of the present invention to provide a method for optimizing efficiency of ground travel of aircraft equipped with onboard non-engine drive motors for autonomous ground movement that integrates the control and operation of onboard non-engine drive motors at appropriate times during ground travel to move the aircraft at speeds specifically selected for optimum autonomous ground travel during at least pushback, initial forward roll, start-stop travel, and other situations requiring an aircraft speed different from a taxi speed.

It is a further object of the present invention to provide a method for optimizing at least time and fuel savings during aircraft ground operations when an aircraft is equipped with onboard non-engine drive motors for autonomous ground movement that selectively controls aircraft ground travel so that the non-engine drive motors are operated only at designated selected aircraft ground travel speeds or maneuvers and one or more of the aircraft's engines are operated only at other designated selected ground travel speeds or maneuvers.

It is yet a further object of the present invention to provide a method for efficiently moving aircraft during ground travel that integrates operation of both aircraft engines and non-engine drive motors to reduce or eliminate aircraft engine throttle settings above an idle setting to move the aircraft during taxi or other ground travel.

In accordance with the aforesaid objects, a method for optimizing efficient ground travel in aircraft equipped with onboard non-engine drive motors for autonomous ground travel is provided. The present method optimizes efficiency of aircraft ground travel and ground maneuvers by integrating the selective operation of the non-engine drive motors with the selective operation of one or more of the aircraft's engines and maximizes the cost/benefit ratio for equipping the aircraft with non-engine drive motors. The non-engine drive motors may be operated to move an aircraft in only a forward direction as required to pull into and out of a terminal parking space or in reverse during pushback. Pilot cockpit controls may be provided that integrate the selective operation and control of both the non-engine drive motors with thrust from the aircraft engines so that ground travel of the aircraft is selectively controlled by the non-engine drive motors or by thrust from one or more aircraft engines, as required by aircraft speed or ground travel conditions.

Other objects and advantages will be apparent from the following description, claims, and drawings.

### BRIEF DESCRIPTION OF THE DRAWINGS

FIG. 1 illustrates an aircraft that is equipped with one or more onboard non-engine drive motors for autonomous ground movement that may also be selectively powered for ground movement by at least one of the aircraft's engines to move the aircraft in accordance with the method of the present invention; and

FIG. 2 illustrates an aircraft equipped with onboard non-engine drive motors entering, parking, and leaving an airport ramp and terminal area at ramp maneuvering speed while moving in only a forward travel direction, wherein ground movement is controlled solely by operation of the non-engine drive motors.

### DESCRIPTION OF THE INVENTION

Increasing the efficiency with which aircraft can move on the ground between landing, airport gate operations, and takeoff enables airlines to move aircraft, passengers, and cargo as quickly and safely as possible. Inefficiencies and delays can have both local and widespread undesirable effects for both passengers and airlines. When aircraft are delayed as a result of inefficient ground movement, larger numbers of passengers are affected than when other aircraft are delayed. Currently, aircraft are moved on the ground solely by the operation of one or more of the aircraft's engines, which may effectively move aircraft on runways or taxiways at the taxi speeds set by airports. Aircraft currently must also travel through a ramp area or apron into a terminal gate or other parking location near an airport terminal with engines operating. Jet blast and engine ingestion hazards associated with operating aircraft engines near an airport terminal have a significant effect on the safety and efficiency with which gate operations can be conducted. When an aircraft is equipped with non-engine drive motors for autonomous ground movement, operation of the aircraft's engines is not required to move the aircraft on the ground. Movement of aircraft within a ramp or gate area by non-engine drive motors is not accompanied by jet blast or engine ingestion hazards. Although all aircraft ground movement in aircraft equipped with non-engine drive motors may be powered by the non-engine drive motors, there are ground travel situations and airport surface conditions in which integrating operation of the aircraft engines with operation of the non-engine drive motors can optimize not only the efficiency and safety of aircraft ground travel, but may also optimize the savings that accompany non-engine drive motor-powered aircraft ground movement.

Aircraft engines operate most efficiently at the speed ranges required for flight. The current practice is, and has been, to reduce throttle settings when aircraft engines are used to power aircraft ground movement during taxi both on runways and in airport ramp or apron areas. Even low throttle settings above idle, however, may produce engine ingestion and jet blast. Aircraft may be required to travel at varied speeds during taxi after landing, into and out of terminal parking areas, and prior to takeoff. Aircraft engines may be operated at the speeds above taxi speed ranges during taxi on runways and taxiways, but do not operate efficiently at these speeds. Engine ingestion and jet blast hazards are created at the lower speed ranges required for ground travel of aircraft into and out of parking locations. In accordance with the present method, non-engine drive motors maybe effectively employed to move aircraft at breakaway to about 5 to 8 miles per hour. Once the aircraft breaks away, idle thrust settings of the engines may move the aircraft at speeds within typical taxi speed ranges.

Landing gear wheel-mounted non-engine drive motors may also be used to move aircraft when airport ground conditions and situations make engine operation particularly hazardous, whether the hazards are produced by topography of an airport's runways and ramps or weather conditions, including ice and snow. While airport ground surfaces may appear to be flat and level, the actual ground surfaces may not be flat, but the surface may be uneven or have dips and ruts, requiring more engine power to move the aircraft than is safe or efficient for a ramp area. Although airlines and the various authorities that operate airports go to great lengths to ensure that the runways, taxiways, and ramp areas are flat and level and do not have significant depressions, tarmac surfaces are not always flat. In a recent situation, for example, an aircraft with a wheel stopped by a dip in a ramp area surface required a 70% throttle setting to get the aircraft moving. Spooling up an aircraft engine to this level not only increases the danger from engine ingestion and jet blast in a congested ramp area, but also increases noise levels near the aircraft and fuel consumption by the aircraft. The use of such higher throttle settings may be more common for breakaway during taxi than to move an aircraft out of a dip in the tarmac, however. Such situations would be avoided by the integrated aircraft ground movement method of the present invention. Since aircraft ground movement would be pilot-controlled and powered by the non-engine drive motors within the airport ramp area, a pilot may control the landing gear wheel-mounted non-engine drive motors to get the aircraft moving, and keep it moving, without these attendant dangers or other negative effects.

The method of the present invention contemplates integrating control of aircraft ground movement using aircraft engines, preferably at throttle settings at idle or below, with control of aircraft ground movement using landing gear wheel-mounted non-engine drive motors. One or more of the engines on the non-engine drive motor-equipped aircraft may be controlled and operated to move the aircraft at higher taxi speeds when it is more efficient to power ground travel with the aircraft's engines. The landing gear wheel-mounted non-engine drive motors may be controlled and operated at the relatively lower ground speeds typically used for pushback, initial forward roll, all start-stop situations, and other low speed ground travel, or to move the aircraft in a forward direction to park at a terminal as described herein. The non-engine drive motors may also be used to move the aircraft during taxi, if required or desired.

The present method may be effectively employed on wide body, narrow body and other types of aircraft. Wide-body aircraft, like the Airbus 380 and the Boeing 747 to 787 series aircraft, typically have two aisles in the passenger compartments and are capable of carrying 200 to 850 passengers, with up to 11 passengers in a row. These aircraft have a fuselage diameter in the range of 5 to 6 meters (16-20 feet). In contrast, narrow body aircraft, which are the majority of aircraft flown today, have a single aisle passenger compartment that seats 2 to 6 people in a row and a fuselage diameter in the range of 3 to 4 meters (10-13 feet). Maneuvering a wide-body aircraft on the ground, particularly within an airport ramp area and near a terminal must take into account not only the substantially larger size of the aircraft compared to narrow body aircraft, but also the significantly larger numbers of passengers that must be accommodated at arrival and departure. Their size and weight also require more power to move wide-body aircraft as they travel on the ground between landing and takeoff than smaller aircraft.

In accordance with the present ground movement method, aircraft are equipped with one or more onboard non-engine drive motors capable of moving the aircraft autonomously on the ground. The one or more non-engine drive motors are designed to one power one or more landing gear wheels to move the aircraft autonomously on the ground without reliance on aircraft main engines or tow vehicles. The preferred location for the drive motors is mounted within each wheel of the aircraft nose landing gear wheels. Providing drive motors on one or more main landing gear wheels may also be suitable in some aircraft. A preferred drive motor is an electric motor assembly, preferably powered by the aircraft auxiliary power unit or another source of electric power, that is capable of operating at the torque and speed required to move landing gear wheels of aircraft of a range of sizes on the ground at the speeds described herein. An example of one of a number of suitable types of drive means useful in an aircraft landing gear drive wheel that could be used effectively in the present method is an inside-out electric motor in which the rotor can be internal to or external to the stator, such as that shown and described in U.S. Patent Application Publication No. 2006/0273686, the disclosure of which is incorporated herein by reference. A range of motor designs capable of high torque operation across a desired speed range that can move an aircraft landing gear wheel and function as described herein to move an aircraft autonomously may also be suitable drive motors useful in the present invention. A high phase order electric motor of the kind described in, for example, U.S. Patent Nos. 6,657,334; 6,838,791; 7,116,019; and 7,469,858, the disclosures of the aforementioned patents being incorporated herein by reference, can be effectively used as a drive motor. One particularly suitable drive motor is a high phase order induction motor with a top tangential speed of about 15,000 linear feet per minute and a maximum rotor speed of about 7200 rpm, although drive motors capable of a wide range of such speeds could be used with the present drive wheel drive system. Other drive motors, including hydraulic and/or pneumatic drive motors, are also contemplated to be useful as landing gear wheel-mounted non-engine drive motors.

It is preferred that the non-engine drive motors selected for use in the present ground movement method be designed to achieve top speeds of and drive an aircraft at least about 5 to 8 miles per hour (mph). This speed range is an optimum range for specific phases of aircraft ground travel, including without limitation, pushback, the initial forward roll, and all start-stop or stop-and-go situations. The non-engine drive motors may also be designed to move an aircraft at higher speeds. Aircraft engines may be enabled to move aircraft in stop-and-go situations, if this produces more efficient aircraft ground travel in specific situations. Since aircraft taxi speed is typically about 15 to 22 mph at most airports, aircraft ground movement at these typical taxi speeds may not be powered by a non-engine drive motor designed to have a top speed of at least about 8 mph. Consequently, in accordance with the present invention, when required, aircraft ground movement at higher taxi speeds, e.g., at least about 15 to 22 mph, may be powered by thrust, preferably at thrust levels at or below idle thrust, from at least one of the aircraft engines, while ground movement at slower ramp and ground operations speeds may be powered by the non-engine drive motors. In the event of high runway traffic, engines may be shut down completely, and the non-engine drive motors activated to control ground travel more efficiently.

The present method integrates engine control with non-engine drive motor control of aircraft ground movement so that neither the aircraft engines nor the non-engine drive motors are operating during all aircraft ground travel. The integrated method described herein optimizes time, fuel, and other savings possible with the operation of non-engine drive motors and maximizes the relationship between cost and benefit of the non-engine drive motors. Control of ground movement of an aircraft by the integrated operation of the aircraft's engines to move an aircraft during high speed taxi and a non-engine drive motor capable of driving the aircraft during selected ground movement events that require lower speeds will be described in more detail in the EXAMPLE below.

A non-engine drive motor designed to drive an aircraft at speeds in the range of about 5 to 8 mph, primarily within a ramp area but also on taxiways and runways when necessary, may be correspondingly smaller and lighter than a non-engine drive motor designed to drive an aircraft at typical high taxi speeds of up to about 30 mph after touchdown and prior to takeoff. The preferred smaller and lighter non-engine drive motor will additionally be sufficiently powerful to move an aircraft on a tarmac surface that is not level without resorting to reliance on thrust from aircraft engines, thereby avoiding the situation described above. Such a smaller and lighter non-engine drive motor, in addition to adding less weight when installed within a landing gear wheel, may significantly reduce any fuel uncertainty, producing a resulting reduction in aircraft flight weight attributable to fuel. The non-engine drive motor would not be required to work 100% of the time during ground movement, but the cost/benefit ratio of moving an aircraft with non-engine drive motors may be maximized. It is estimated that a non-engine drive motor designed to move an aircraft at the low speeds described and during the ground movement periods described herein can provide about 80% of the benefit of a non-engine drive motor operating full time to power aircraft ground movement.

A smaller, lighter non-engine drive motor than those proposed in the art that may be selectively employed with the selective operation of the aircraft of the aircraft's engines to move the aircraft on the ground at desired safe speeds appropriate for airport ground travel conditions may be one of a number of electric motors. One type of non-engine drive motor that may be mounted completely within an aircraft landing gear nose or main landing gear wheel and modified for the selective, part-time aircraft ground movement described herein is a high phase order electric motor of the kind described in, for example, U.S. Pat. Nos. 6,657,334; 6,838,791; 7,116,019; and 7,469,858, or a geared motor, such as that shown and described in U.S. Pat. No. 7,469,858, all of which are owned in common with the present invention. The disclosures of the aforementioned patents are incorporated herein by reference. The drive motor selected should be able to drive an aircraft wheel at a desired speed and torque capable of moving a variety of different kinds of aircraft on the ground at speeds of at least about 5 to 8 mph.

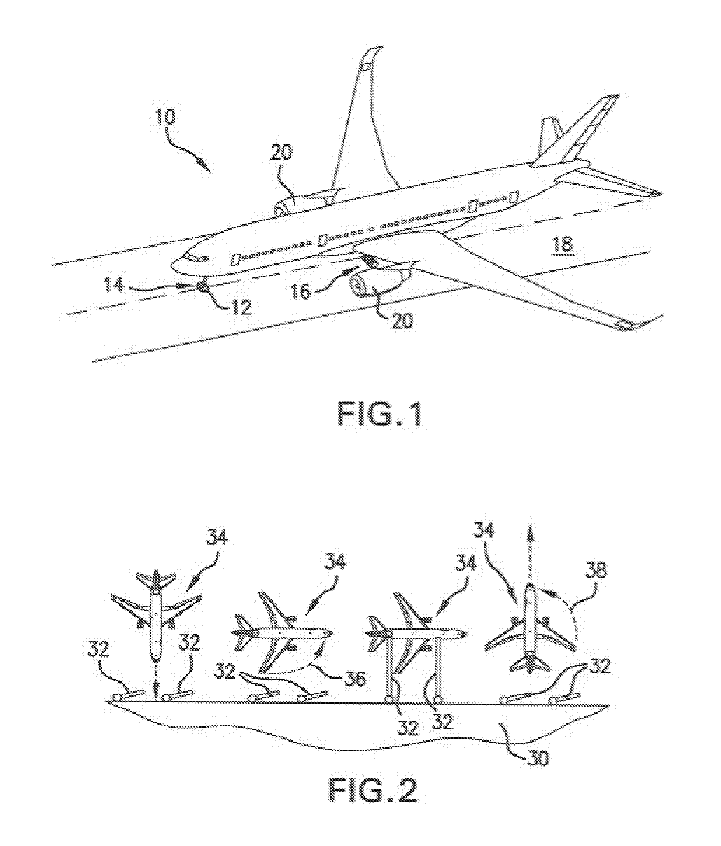

Referring to the drawings, FIG. 1 illustrates an aircraft 10 equipped with one or more of the onboard non-engine drive motors 12, as described above, mounted completely within the aircraft's nose landing gear wheels 14. One or more non-engine drive motors may, alternatively or in addition, be mounted in one or more of the aircraft's main landing gear wheels 16. The aircraft 10 of FIG. 1 is shown taxiing on a runway 18. In accordance with present aircraft ground movement method, one or more of the aircraft's main engines 20, rather than the non-engine drive motor 12, may be operating to power the aircraft's ground travel during taxi at taxi speeds of at least about 15 to 22 mph on a runway as shown.

As noted above, movement of wide body and other aircraft into and out of ramp areas and terminal gates can present challenges, in large part because of the size and the large numbers of passengers to be accommodated at the terminal for wide body aircraft and the numbers of other aircraft moving into and out of the ramp area. A system for moving aircraft into and out of gates and parking stands so that passengers can exit and enter the aircraft with greater efficiency than was previously possible is described in commonly owned co-pending patent application Ser. No. 14/341,735, filed 25 Jul. 2014, and entitled Airport Terminal Aircraft Gate Traffic Management System and Method, the disclosure of which is fully incorporated herein by reference. The system described in the aforementioned patent application directs aircraft equipped with onboard non-engine drive motors for autonomous ground movement into and out of gates, parking stands, and other parking locations by controlling the non-engine drive motors to move the aircraft in only a forward direction to park in an orientation parallel to an airport terminal and then to leave the parking location in a forward direction as shown in FIG. 2.

Movement of aircraft in only a forward direction with non-engine drive motors increases the safety and efficiency of gate operations by eliminating jet blast and engine ingestion hazards associated with operating aircraft engines near an airport terminal, as well as reducing the numbers of ground personnel and vehicles needed to support engines-on taxi within the ramp area. Aircraft taxi with non-engine drive motors may be controlled primarily by aircraft pilots, who can direct aircraft maneuvers into and out of gate and stand parking. The efficiency of passenger movement into and out of a parked aircraft is maximized by the ability to use all forward and rear aircraft passenger doors for deplaning and boarding, simultaneously, if desired. Flexibly movable jet bridges may be spaced and extended to connect with doors on a parked aircraft and then retracted to maximize space at a parking location so the aircraft has at least the minimum clearance required to turn and leave the parking location at departure. At many airports around the world, passenger access stairs are required, and stairs may be used to move passengers off and on the aircraft simultaneously from forward and rear doors on both sides of the aircraft, as described below. Servicing of aircraft can begin virtually immediately upon arrival at a parking space and can be made more efficient by providing fixed dedicated services equipment designed to connect directly to aircraft at the parking location.

FIG. 2 illustrates forward movement of an aircraft into and out of an airport terminal gate. An aircraft terminal 30 has a number of flexibly movable jet bridges 32. The jet bridges 32 are shown to be rotatably attached to the terminal 30 to rotate into and out of connection with aircraft doors. Other terminal and/or ground attachment structures and methods may also be used. The movement of an aircraft 34 equipped with non-engine drive motors as described above is controlled by pilot operation of the non-engine drive motors as the aircraft approaches the terminal in a nose-in position and then rotates or turns 90° along a path shown by arrow 36 to park with the longest axis of the aircraft parallel to the terminal. The flexibly movable jet bridges 32 attached to the terminal may be spaced to permit simultaneous connections to forward and rear aircraft doors. The jet bridges 32 may remain in the retracted position close to the terminal 30 shown to provide a maximum amount of space for an aircraft while it is maneuvering at the gate to facilitate parking of the aircraft parallel to the terminal. Upon arrival at the terminal 30, the aircraft 34 turns 90° as described and is moved by the non-engine drive motors to an assigned gate parking space or stand. Once the aircraft has parked, two flexible movable jet bridges 32 may be extended to connect with the aircraft front and rear doors. Although it is not as efficient for moving passengers out of and into the aircraft, if necessary, only one jet bridge may be connected to the aircraft at airport terminals that do not have the preferred optimum arrangement of jet bridges.

When departing passengers have boarded and the aircraft 34 is ready for departure, the jet bridges 32 may be moved away from the aircraft to clear the parking space. The aircraft pilot may activate and control the non-engine drive motors to move the aircraft 34 in a forward direction and turn it 90° along the path shown by arrow 38 so that the aircraft nose is pointed away from the terminal 30. The pilot may then drive the aircraft in a forward direction away from the terminal to a taxiway or takeoff runway, where at least one of the aircraft engines may be activated to move the aircraft during taxi.

All of the aircraft movements shown in FIG. 2 are in a forward direction. This provides an aircraft pilot with the ability to keep the aircraft travel area in view while controlling the one or more non-engine drive motors to turn and move the aircraft into or out of the terminal parking area. Driving the aircraft in reverse, while not necessary with the present ground movement method, can also be done by controlling the non-engine drive motors to move the aircraft in reverse.

When the flexibly movable jet bridges 32 are connected to both front and rear doors of the aircraft, passengers, crew, cleaning and other service personnel can be moved into and out of the aircraft using both doors while it is parked at the gate, increasing the efficiency and decreasing the time for turning the aircraft around. Since aircraft engines are not used within the ramp area in the present aircraft ground movement method, ground services vehicles and personnel can approach the aircraft as soon as it is parked at the terminal, and baggage and cargo transfer, fueling, catering, and other services can be commenced without having to wait until the engines are completely shut down to avoid the adverse effects associated with operating aircraft engines.

The present aircraft ground movement method has been discussed in connection with the use of passenger loading bridges or jet bridges at terminal gates or stands to transfer passengers between an airport terminal and the aircraft. In some airports, terminal gates do not provide sufficient space between jet bridges or parking stands to accommodate large aircraft. In addition, airports in many countries do not have terminal buildings with jet bridges. In these airports, when an aircraft arrives at a gate, either the aircraft's stairs are lowered or ground personnel bring portable stairs to aircraft that do not have integral stairs. Aircraft equipped with non-engine drive motors to move the aircraft autonomously on the ground are able to move closer to a terminal and to lower their stairs or have portable stairs brought to the aircraft as soon as the aircraft has come to a stop without waiting for the aircraft's engines to be turned off and the turbines to stop moving. The doors can be opened as soon as the stairs are in place, and passengers can leave the aircraft immediately. Since aircraft typically have at least two front and two rear doors, stairs could be provided for all four or more doors. When all four doors are used by the passengers exiting the aircraft, it is possible to empty the aircraft very quickly. Deplaning and boarding may be conducted simultaneously, with deplaning passengers leaving by one set of doors and boarding passengers by another set. Aircraft that use stairs instead of jet bridges may park closer to gates and terminal services, thus minimizing the distance passengers and crew need to walk to and from the aircraft and the gate or terminal building.

Operation of the present ground movement system for aircraft equipped with non-engine drive motors is described in the following EXAMPLE.

### EXAMPLE

An aircraft is equipped with one or more non-engine drive motors, preferably one of the electric motors described above that is designed to drive the aircraft at a top speed of about 5 to 8 mph, mounted completely within each of the aircraft's nose landing gear wheels. The non-engine drive motor-equipped aircraft lands at an airport, and thrust from the aircraft engines is used to move the aircraft at the airport's taxi speed on a runway from a touchdown location along a taxi path toward the aircraft's designated arrival location in an airport ramp area. If the runway traffic is heavy or if the aircraft must come to a stop during taxi, for example to wait for another aircraft at a crossing runway, the aircraft engines are shut off, and the nose landing gear electric drive motors are activated and controlled to move the aircraft forward after the stop. The aircraft then travels at a speed within the about 5 to 8 mph speed range of the non-engine drive motors to its arrival location.

If the aircraft is not required to stop on a runway, the engines at a setting no higher than idle thrust may control aircraft ground travel until the aircraft's arrival outside the ramp area. The idle thrust setting will vary, depending on the specific engines powering the aircraft. The aircraft's engines are shut down at a convenient location outside the ramp area or apron, and aircraft ground movements in this usually congested area are controlled entirely by operation of the electric drive motors. The aircraft is driven forward by the electric drive motors to a designated parking destination, where the aircraft may be driven with the electric drive motors to make a 90° turn before coming to a complete stop at a parking location so that the longest axis of the aircraft is parallel to the terminal, as shown and described in connection with FIG. 2. Alternatively, the aircraft may be parked in a nose-in orientation. Jet bridges or stairs are provided, and passengers exit the aircraft through front and rear doors. The aircraft may be prepared to receive passengers for the aircraft's departing flight simultaneously with the exit of arriving passengers, as well as to load the departing passengers through both front and rear doors while cargo and baggage are loaded. Jet bridges or stairs are moved away from the aircraft.

The aircraft is cleared for departure, the pilot activates and controls the electric drive motors, and to drive the aircraft in an initial forward roll to then make a 90° turn or in a reverse direction to move the aircraft away from the terminal. The pilot continues to control the electric drive motors to drive the aircraft at a speed of about 5 to 8 mph or another safe ground travel speed for the ramp conditions out of the ramp area and onto a taxiway and/or takeoff runway. On the taxiway or runway, the electric drive motors may be deactivated, and one or more of the aircraft's engines may be started. The aircraft is driven on the ground at a desired taxi speed by power from one or more of the aircraft engines at a throttle setting required for taxi to a takeoff location at a taxi speed of about 15 to 22 mph or another safe or efficient taxi speed for airport conditions.

The present method for part-time operation of non-engine drive motors integrated with part-time operation of aircraft engines as described above may require providing cockpit controls that are simplified, compared to what may be needed for the full-time operation of non-engine drive motors. Cockpit controls provided may include, for example without limitation, at least a non-engine drive motor power off/on switch, a forward drive knob or button, a reverse button (preferably guarded to prevent inadvertent activation), and a warning indicator. A warning indicator could communicate, for example, that one or more of the non-engine drive motors is not operating properly or that the drive motors are operating when they should not be operating, so that the pilot can manually inactivate the non-engine drive motors, if necessary.

The integrated ground movement method of the present invention may be effectively used to power and control taxi and ground movement in aircraft of a range of sizes, including those aircraft designated as narrow body and wide body aircraft. A large portion of the benefit associated with non-engine drive motor-controlled aircraft taxi can be realized with simpler non-engine drive motors than those proposed previously that works part time with the aircraft engines to optimize the savings possible when aircraft are equipped with non-engine drive motors that may be activated for autonomous ground movement. The present method makes it possible to maximize the overall aircraft operational benefits that are realized when an aircraft is equipped with onboard non-engine drive motors and moved on the ground in conjunction with the selective operation of at least one of the aircraft's engines at an idle thrust setting as described above. Consequently, the costs and benefits of operating the non-engine drive means to move the aircraft on the ground and the costs and benefits of operating the aircraft's engine to move the aircraft on the ground are balanced to maximize overall aircraft operational benefits.

While the present invention has been described with respect to preferred embodiments, this is not intended to be limiting, and other arrangements and structures that perform the required functions are contemplated to be within the scope of the present invention.

### INDUSTRIAL APPLICABILITY

The ground movement method for aircraft equipped with non-engine drive motors that integrates selective operation of aircraft engines with selective operation of non-engine drive motors to power aircraft ground movement as described herein will find its primary applicability when it is desired to move aircraft between landing and takeoff at an airport with maximum safety and efficiency while optimizing savings possible with the use of non-engine drive motors to control and power aircraft ground movement.

1. A method for increasing efficiency of aircraft ground travel from an aircraft landing location, into and out of an airport terminal parking location, and then to a takeoff location in aircraft equipped with non-engine drive motors for autonomous ground movement, comprising:
a. equipping both wheels of an aircraft nose landing gear in an aircraft powered by one or more engines with non-engine drive motors mounted completely within each of the nose landing gear wheels and controllable by a pilot of the aircraft to drive the aircraft autonomously without operation of the one or more engines at an optimal ground speed for selected ground travel locations and operations;
b. selectively controlling only the non-engine drive motors and driving the aircraft at the optimal ground speed during ground travel at the selected ground travel locations and during the selected ground travel operations; and
c. selectively controlling operation of the one or more engines to move the aircraft on an airport ground surface only at an airport taxi speed during other selected ground travel taxi operations and at other selected ground travel locations without operation of the non-engine drive motors.

2. The method of claim 1, wherein the selected ground travel operations comprise one or all of pushback, initial forward roll, start-stop situations, and into and out of an airport terminal parking location.

3. The method for claim 1, wherein the selected ground travel locations comprise at least airport ramp areas or aprons.

4. The method of claim 1, further comprising selectively controlling operation of only the non-engine drive motors to move the aircraft at the optimal ground speed for the selected ground travel locations and operations comprising breakaway to ground travel speeds in the range of about 5 to 8 miles per hour.

5. The method of claim 1, further comprising selectively controlling operation of the one or more engines to move the aircraft at the only at an engine thrust setting of idle or below idle or at an airport taxi speed in the range of at least about 15 to 22 miles per hour.

6. The method of claim 1, further comprising selectively controlling operation of only the one or more engines to move the aircraft during the other selected ground travel taxi operations and at the other selected ground travel locations comprising taxi of the aircraft after landing to a location outside an airport ramp area and taxi of the aircraft from the location outside the airport ramp area to a takeoff location.

7. The method of claim 1, further comprising selectively controlling operation of only the one or more engines to move the aircraft during the other selected ground travel taxi operations and at the other selected ground travel locations comprising taxi of the aircraft after landing to a location outside an airport ramp area and taxi of the aircraft from the location outside the airport ramp area to a takeoff location and selectively controlling operation of only the non-engine drive motors to move the aircraft during ground travel at the selected ground travel locations comprising at least airport ramp areas or aprons.

8. The method of claim 7, further comprising selectively controlling operation of the one or more engines to move the aircraft only at an engine thrust setting of idle or below idle or at an airport taxi speed in the range of at least about 15 to 22 miles per hour during the other selected ground travel taxi operations.

9. The method of claim 7, further comprising selectively controlling operation of only the non-engine drive motors to move the aircraft at ground travel speeds comprising breakaway to speeds in the range of about 5 to 8 miles per hour.

10. The method of claim 1, further comprising equipping both wheels of the aircraft nose landing gear with the non-engine drive motors by mounting high phase order electric motors completely within each nose landing gear wheel.

11. The method of claim 1, further comprising providing controls in a cockpit of the aircraft integrated to selectively activate and control only the non-engine drive motors to drive the aircraft at the selected ground travel locations and during the selected ground travel operations and to selectively activate and control operation of only the one or more engines to drive the aircraft during the other selected ground travel taxi operations and at the other selected ground travel locations.

12. A method for optimizing efficiency of aircraft ground travel at an airport between landing and takeoff in aircraft powered for ground travel by landing gear wheel-mounted non-engine drive motors and by aircraft engines, comprising,
in an aircraft equipped with pilot-controllable electric drive motors mounted completely within one or more nose landing gear wheels, one or more engines controllable to power the aircraft in flight and on the ground, and pilot controls to selectively control operation of the electric drive motors and operation of the one or more engines,
selectively controlling the one or more engines to move the aircraft at ground travel speeds of at least about 15 to 22 miles per hour for a portion of the aircraft's ground travel on a runway or taxiway between landing and takeoff, and
selectively controlling the electric drive motors to move the aircraft at ground travel speeds of about 5 to 8 miles per hour for another portion of the aircraft's ground travel comprising one or all of pushback, initial forward roll, start-stop situations, and into and out of an airport terminal parking location.
